(19) United States
(12) Patent Application Publication
(10) Pub. No.: US 2017/0198876 A1
(43) Pub. Date: Jul. 13, 2017

(54) LIGHTING DEVICE EQUIPPED WITH A CURVED WAVELENGHT CONVERSION ELEMENT, AND HEADLIGHT COMPRISING SUCH A LIGHTING DEVICE

(71) Applicant: VALEO VISION, Bobigny Cedex (FR)

(72) Inventor: Loic BOINET, Le Mesnil Esnard (FR)

(73) Assignee: VALEO VISION, Bobigny Cedex (FR)

(21) Appl. No.: 15/402,710

(22) Filed: Jan. 10, 2017

(30) Foreign Application Priority Data
Jan. 11, 2016 (FR) 16 50203

(51) Int. Cl. F21S 8/10

(52) U.S. Cl. CPC F21S 48/1225; F21S 48/1145; F21S 48/1291; F21S 48/1258; F21S 48/1757; F21Y 2115/30

(57) ABSTRACT

The invention relates to a lighting device (1), in particular for an automotive vehicle, comprising at least one light source (2) capable of emitting light rays (6) to form a light beam (17) and an optical projection system (4) configured to project the light beam (17) along an optical axis (16), characterized in that it additionally comprises a wavelength conversion element (5) configured to receive the light rays (6) emitted by the light source (2) and to re-emit light radiation creating said light beam (17) in the direction of the optical projection system (4), and scanning means (3) configured to scan the light rays (6) emitted by the light source (2) over the conversion element (5), the conversion element (5) being convexly curved toward the scanning means (3).

The present invention relates to a lighting device equipped with a curved wavelength conversion element, in particular for an automotive vehicle, and a lighting and/or signaling system equipped with such a lighting device.

Automotive vehicle headlights are equipped with one or more optical modules arranged within a housing closed by an outer lens so as to obtain one or more light beams as output from the headlight, In a simplified manner, an optical module of the housing comprises, in particular, a light source, for example one (or more) light-emitting diode(s), which emits light rays, and an optical system comprising one or more lenses and, if necessary, an optical element, for example a reflector, so as to orient the light rays arising from the light sources in order to form the light beam as output from the optical module.

Additionally, other technologies may be used for these devices. Thus, there exist laser diodes which may advantageously replace the light-emitting diodes. However, the color of the typical lasers does not correspond to the regulation colors of such headlights. The module then comprises a wavelength conversion element, which receives the light beam from the laser source and re-emits it as white light toward an optical projection system and thus forms a portion of the light beam of the headlight.

To illuminate a wider area of the conversion element with a light beam, means for scanning the light beam are required. The scanning is carried out at a frequency that is high enough for the human eye not to perceive the movement and to see the beam exiting the module as continuous illumination.

The known scanning means are, for example, elements of MEMS (microelectromechanical systems) type, comprising one or more micromirrors which reflect the laser beam onto the area. These micromirrors are, for example, capable of at least one rotary movement about an axis which causes the area to be scanned in a first direction. A second micromirror, or another rotary movement of the first mirror about a second axis that is perpendicular to the first axis, makes it possible to scan in two directions. This results in the laser beam scanning the area.

The scanning of the beam is carried out from one edge to the other of the illuminated area of the conversion element. However, the scanning cannot be at a constant speed over the entire breadth of the area. Specifically, the scanning must stop at each edge of the area in order to set off in another direction toward the other edge. As a result, the light re-emitted by the conversion element is not uniform, the illumination of the edge of the illuminated area being more intense than that of the center. However, it is instead desired to have a beam which is brighter at the center than at the edges, in order to comply with the regulations in force.

The invention therefore aims to obtain a lighting device that improves the situation and avoids the aforementioned failings, in particular in order to obtain illumination of greater uniformity.

For this purpose, the invention relates to a lighting device, in particular for an automotive vehicle, comprising at least one light source capable of emitting light rays to form a light beam and an optical projection system configured to transmit the light beam along an optical axis.

The device is remarkable in that it additionally comprises a wavelength conversion element configured to receive the light rays emitted by the light source and to re-emit light radiation creating said light beam in the direction of the optical projection system, and scanning means configured to scan the light rays emitted by the light source over the conversion element, the conversion element being convexly curved toward the scanning means.

Thus, the curvature of the conversion element accentuates the difference in distance between the source of the light beam and the various portions of the conversion element. Stated otherwise, the most convex portion of the surface of the conversion element is closer to the source than the other portions of the surface. This difference in distance leads to a difference in the intensity received by the conversion element and transmitted by the latter. By virtue of such a conversion element, it is possible to compensate for the lack of luminous intensity at the center with respect to the edges of the beam transmitted by the conversion element. In this way a more uniform beam, or even one in which the luminous intensity at the center is increased with respect to the edges, is obtained.

According to various embodiments of the invention which may be taken together or separately:
the scanning means are configured to make the light rays emitted by the light source scan in a first direction;
the conversion element is substantially cylindrical;
the cylindrical form is defined by a directrix curve and a generatrix line;
the scanning means are configured to make the light rays scan over the conversion element in a direction that is substantially orthogonal to the generatrix line;
the conversion element takes a substantially paraboloidal, spherical or toroidal form;
the conversion element takes a substantially conical form;
the conversion element is configured so that the wavelength of the re-emitted light radiation is different from that of the received light rays in order to obtain a desired color;
the desired color is, for example, a white light;
the scanning means are configured to make the light rays scan in a second direction;
the scanning means are equipped with a movable micromirror configured to reflect the light rays emitted by the light source so as to scan the conversion element in a first direction and/or in a second direction;
the same micromirror makes the light rays scan the surface of the conversion element in both directions;
the scanning means are equipped with two micromirrors configured to make the light rays scan in the first direction and in the second direction, respectively;
the scanning means are arranged substantially on the optical axis of the projection system;
the one or more micromirrors are capable of a periodic movement produced by an actuator;
the conversion element is arranged on the optical axis of the optical projection system;
the optical projection system is configured for a curved conversion element;
the field curvature of the projection system substantially corresponds to the curvature of the conversion element;
the conversion element comprises a substrate and a layer of a photoluminescent material;
the substrate is transparent;
the photoluminescent material contains, for example, phosphorous or yttrium aluminum garnet;
the light source comprises at least one laser diode.

The invention also relates to a lighting and/or signaling system for an automotive vehicle, comprising such a lighting device. The system preferably comprises a means for supplying electrical power to the light source, configured so that the light source emits light rays whose luminous intensity is constant when it is supplied with power.

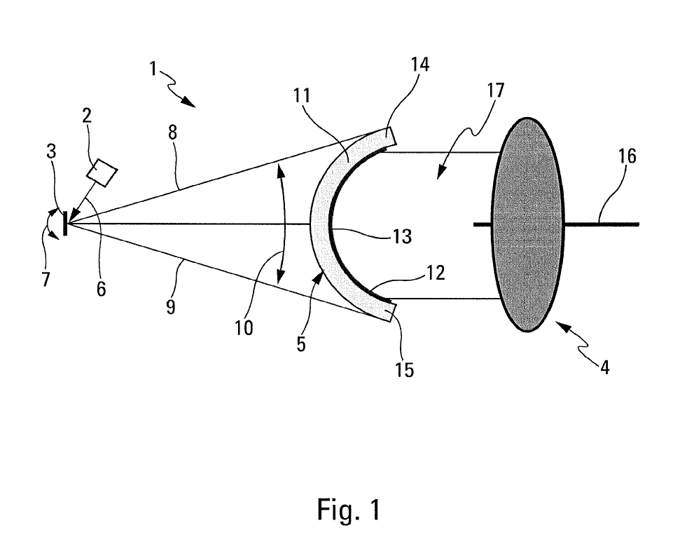

The invention will be better understood in light of the following description, which is given only by way of indication and is not intended to be limiting, accompanied by FIG. 1 which schematically illustrates a cross-sectional view in profile of one embodiment of a lighting device according to the invention.

FIG. 1 shows a lighting device 1 according to one embodiment of the invention, in particular for a lighting and/or signaling system for an automotive vehicle, comprising at least one light source 2 capable of emitting light rays in order to form a light beam 6. In this instance, the light source 2 is, for example, one or more laser diodes. The light source 2 may also comprise an optical device combining, in a single beam, multiple laser beams, for example using optical fibers or devices making use of the various polarizations of various laser sources. The system preferably comprises a means for supplying electrical power to the light source 2, configured so that the light source 2 emits light rays 6 whose luminous intensity is constant when it is supplied with power.

The device 1 comprises a wavelength conversion element 5 configured to receive light rays from the light source 2 and to re-emit other light rays whose wavelength is different from that of the received light rays. The conversion element 5 makes it possible, for example, to obtain a desired color for the light of the headlight, for example a white light from blue light rays. The conversion element 5 comprises, in this instance, a transparent substrate 11 and a layer 12 of a photoluminescent material, for example based on phosphorous or on yttrium aluminum garnet (known by the acronym YAG). Thus, the conversion element 5 converts light rays 6 emitted by the light source to a light beam 17 of a different color from that of the rays. The conversion element 5 may, depending on the case, convert a portion only or most of the light rays emitted by the source 2 in order to form the light beam 17.

The device 1 is equipped with an optical projection system 4 which is used to collimate the light beam 17 arising from the conversion element and to transmit it as a light beam along an optical axis 16 toward the exterior of the device 1. For this purpose, the optical projection system 4 is substantially arranged on the optical axis of the conversion element 5.

The device 1 is additionally equipped with scanning means 3 arranged on the axis of the conversion element 5, on the opposite side with respect to the optical projection system 4. The scanning means 3 receive the light rays 6 from the source 2 and forward them to the conversion element 5. Thus, the conversion element 5 is positioned between the scanning means 3 and the optical projection system 4, the light beam 17 being re-emitted by the conversion element 5. The scanning means are configured to scan the light beam 6 over the conversion element 5. The scanning is carried out at a speed that is high enough for the human eye not to perceive the scanning and for the conversion element to emit a light beam that appears substantially continuous to the eye. As illustrated by the arrow 10 in FIG. 1, the rays 6 scan the conversion element 5 between two end positions 8 and 9. The two positions 8 and 9 are preferably chosen to illuminate the ends 14, 15 of the conversion element 5, and thus cover substantially all of the surface of the conversion element 5.

In a first variant embodiment, the scanning means 3 are, for example, equipped with a movable micromirror allowing the conversion element 5 to be scanned by reflecting the light rays 6 toward the conversion element 5. The scanning is carried out in a first direction along the surface of the conversion element 5, which is, for example, vertical. The micromirror is capable of a periodic movement produced by an actuator (not shown), which uses, for example, a resonance effect of the micromirror caused, for example, by electrodes to make it oscillate. The movement of the micromirror, represented by the arrow 7, is carried out about an axis of rotation that is orthogonal to the first direction so that the light rays 6 scan the surface of the conversion element 3 in said first direction.

In a second variant embodiment, the scanning means 4 are also configured to scan the conversion element 3 with the light rays 6 in a second direction. The second direction is preferably substantially perpendicular to the first direction in order to produce a movement of the rays 6 which easily travels across the conversion element 5.

Stated otherwise, it is the same micromirror that scans the surface of the conversion element 5 with the light rays 6 in both directions. The micromirror therefore undergoes another movement, for example a rotary movement about a second axis of rotation that is perpendicular to the preceding. Thus, the micromirror allows the conversion element 5 to be scanned both horizontally and vertically.

A third variant embodiment, not shown in the figures, consists of using a second micromirror to make the light rays scan in a second direction. In this case, the scanning means are equipped with two micromirrors positioned one after the other on the optical path of the beam, the function of each being to make the light rays scan the conversion element, each in one of the two directions.

In the description, the micromirrors mentioned as scanning means are, for example, of MEMS (microelectromechanical systems) type. However, the invention is in no way limited to this scanning means and may use other types of scanning means such as, for example, a series of mirrors arranged on a rotary element, the rotation of the element causing the conversion element to be scanned by the light beam.

According to the invention, the conversion element 5 is convexly curved toward the scanning means 3. Thus, the center portion 13 of the conversion element 5 is closer to the scanning means 3, and the ends 14, 15 are further away. Thus, the center portion 13 transmits a higher luminous intensity of the light rays 6 than the ends 14, 15. Thus, the light beam 17 re-emitted by the conversion element 5 is more intense in the middle than at the edges.

Additionally, the optical projection system 4 is configured for a curved conversion element 5 in order to obtain a more uniform light beam. The field curvature of the projection system substantially corresponds, for example, to the curvature of the conversion element. For this purpose, it may comprise a plurality of lenses.

In a first embodiment, the conversion element 5 is substantially cylindrical, the cylindrical form being defined by a directrix curve and a generatrix line. The scanning means are preferably configured to make the light rays 6 scan over the conversion element 5 in a direction that is substantially orthogonal to the generatrix line. Thus, the remote ends 14, 15 of the conversion element 5 substantially correspond to the two scanning end positions 8, 9 of the light rays 6. Scanning means 3 with a single dimension are therefore preferably used.

In a second embodiment, the conversion element 5 takes a substantially parabolic, or spherical, form. In this instance, the scanning means 3 preferably make the light rays 6 scan in two dimensions. Specifically, in two dimensions, the rays 6 scan in two directions, and therefore have two pairs of positions, such as 8 and 9, of the light beam 6, one pair per scanning direction. Such a form for the conversion element 5 allows the conversion element 5 to have remote ends 14, 15 for both pairs of positions.

1. Lighting device, in particular for an automotive vehicle, comprising at least one light source capable of emitting light rays to form a light beam and an optical projection system configured to project the light beam along an optical axis, characterized in that it additionally comprises a wavelength conversion element configured to receive the light rays emitted by the light source and to re-emit light radiation creating said light beam in the direction of the optical projection system, and scanning means configured to scan the light rays emitted by the light source over the conversion element, the conversion element being convexly curved toward the scanning means.

2. Device according to claim 1, wherein the scanning means are configured to make the light rays emitted by the light source scan in at least a first direction.

3. Device according to claim 2, wherein conversion element is substantially cylindrical.

4. Device according to claim 2, wherein the conversion element takes a substantially paraboloidal, spherical or toroidal form.

5. Device according to claim 2, wherein the conversion element takes a substantially conical form.

6. Device according to claim 2 wherein the scanning means are configured to make the light rays scan in a second direction.

7. Device according to claim 2 wherein the scanning means are equipped with a movable micromirror configured to reflect the light rays emitted by the light source so as to scan the conversion element in a first direction and/or in a second direction.

8. Device according to claim 6, wherein the scanning means are equipped with two micromirrors configured to make the light rays scan in the first direction and in the second direction, respectively.

9. Device according to claim 1 wherein the scanning means are arranged substantially on the optical axis of the projection system.

10. Device according to claim 1 wherein the conversion element is arranged substantially on the optical axis of the projection system.

11. Device according to claim 1 wherein the optical projection system is configured for a curved conversion element.

12. Device according to claim 1 wherein the conversion element comprises a substrate and a layer of a photoluminescent material.

13. Device according to claim 1 wherein the light source comprises at least one laser diode.

14. Lighting and/or signaling system for an automotive vehicle, comprising a lighting device according to claim 1.

15. System according to claim 1 comprising a means for supplying electrical power to the light source, configured so that the light source emits light rays whose luminous intensity is constant when it is supplied with power.
